(19) United States
(12) Patent Application Publication
(10) Pub. No.: US 2009/0204977 A1
(43) Pub. Date: Aug. 13, 2009

(54) EVENT MANAGEMENT SYSTEM

(75) Inventors: David Tavares, Toronto (CA); Jason Wilson, Toronto (CA)

Correspondence Address: DENNISON ASSOCIATES, 133 RICHMOND STREET WEST, SUITE 301, TORONTO, ON, M5H 2L7, CA

(73) Assignee: GLOBESTAR SYSTEMS, Toronto (CA)

(21) Appl. No.: 12/414,526

(22) Filed: Mar. 30, 2009

Related U.S. Application Data
(63) Continuation of application No. 10/722,560, filed on Nov. 28, 2003, now abandoned.

(51) Int. Cl. G06F 9/44; G06F 9/46

(52) U.S. Cl. 719/318; 718/102

(57) ABSTRACT

The present invention is directed to an event management system for managing event notifications between disparate systems. Specifically, the present invention is directed to: capture event notifications from any external systems or devices capable of generating an event notification; process said event notifications through a multitude of user-configurable settings including selection of one or more other systems or devices capable of receiving an event notification through assignment of one or more event notification paths based upon one or more of the nature of the event notification, the first external system or device and the one or more other systems or devices; deliver said event notifications to any internal or external systems or devices capable of receiving an event notification; facilitate lateral communication between the device that generated an event notification and a device that received it; permanently record the details of an event notification and its life within the system for any purpose, including auditing. The present invention facilitates comprehensive and multi-tiered programming of the system settings, including the assignment of event notification paths between event-generating devices and event-receiving devices. Such settings may be applied in a static, scheduled or dynamic manner, or any combination of the three.

### REFERENCE TO RELATED APPLICATIONS

This application is a continuation-in-part of application Ser. No. 10/722,560, filed Nov. 28, 2003.

### FIELD OF THE INVENTION

The present invention is directed to an event management system for managing event notifications between disparate systems. In particular, the present invention is directed to an event management system to: capture event notifications from any external systems or devices capable of generating an event notification; process said event notifications through a multitude of user-configurable settings including selection of one or more other systems or devices capable of receiving an event notification through assignment of one or more event notification paths based upon one or more of the nature of the event notification, the first external system or device and the one or more other systems or devices; deliver said event notifications to any internal or external systems or devices capable of receiving an event notification; facilitate lateral communication between the device that generated an event notification and a device that received it; permanently record the details of an event notification and its life within the system for any purpose, including auditing. The present invention facilitates comprehensive and multi-tiered programming of the system settings, including the assignment of event notification paths between event-generating devices and event-receiving devices. Such settings may be applied in a static, scheduled or dynamic manner, or any combination of the three.

### BACKGROUND OF THE INVENTION

Businesses rely on a multitude of event-generating systems. These range in complexity from basic contact devices like a pushbutton or a switch, to the large commercial nursecall systems used in hospitals.

Usually it is a human being who must respond to the occurrence of an event. For example: a patient in a hospital presses her bedside call button to request the assistance of a nurse. Sometimes an automated response is all that is required: e.g. a thermostat exceeding its upper tolerance triggers the air-conditioner to turn on. Events vary in importance as well. When an event occurs, it is critical that:
the proper personnel are notified in a timely manner based on the importance of the event, and/or
the proper automated response is triggered.

Traditional systems have been developed to address these issues. For Example:
Today's nursecall systems incorporate a central monitoring station from which a nursing supervisor can monitor incoming callpoint events, and manually dispatch personnel to deal with the situation.
A factory's automated manufacturing line malfunctions. A computer program on the supervisor's PC sounds an alarm.
A thermostat is hard-wired to an air-conditioner, causing it to activate when a certain temperature is exceeded.

The use of technology can greatly improve the speed and efficiency of event notification delivery. Cell phones, pagers and wireless phones are three popular types of communication devices for receiving time-critical, text-based notifications. Today's most advanced systems have begun to incorporate these devices. A few proprietary nursecall systems allow for integration to a specific local-area paging system, or to a specific wireless phone system. Assignments between a particular callpoint on the nursecall system and a particular device can be programmed through a touch-screen interface.

These systems are greatly limited in their flexibility and programmability. They fail to take a macroscopic view of the notification process. Often, the only concern being addressed is the direct extension of event notification from the proprietary system to a particular mobile device. Many of these systems use proprietary communication protocols, and hence each integration is proprietary itself. For example: nursecall system A creates an integration mechanism to wireless phone system X. Nursecall system B also creates an integration mechanism to wireless phone system X. Since the integration mechanisms for A and B are both proprietary and mutually incompatible, system A and system B cannot both be connected to system X at once. Since hospitals often have multiple nursecall systems installed, this inability to connect disparate event-generating systems to a single event-receiving system is a real and current problem.

There thus remains a need for a comprehensive event management system capable of addressing the above noted issues.

### SUMMARY OF THE INVENTION

The present invention is directed to an event management system capable of addressing (among others) the following issues:
Connectivity: A business needs to integrate multiple proprietary event-generating systems into multiple proprietary event-receiving systems.
Standardization: The event management system uses standard PC hardware and the existing IP network infrastructure to seamlessly integrate these proprietary systems.
Translation: A nursecall call-button event is sent to a text-capable wireless phone, an analogue desk phone, a pager and a warning light. The original data associated with the event consists of the room number and device type stored in the nursecall system. The event management system translates the event data to a suitable format for each of the receiving devices. The wireless phone receives a text message, with the option to call back to the patient room presented on a programmable button. The desk phone receives an audio call containing the same information translated through text-to-speech, with the callback option presented as a touch-tone menu option. The pager, being a one-way communication device, receives only the text message. The warning light is turned on.
Monitoring: One of the integrated notification systems malfunctions. The proper personnel are automatically notified.
Acknowledgement: An event notification is received on a two-way communication device. The user presses a button to acknowledge that he has received the event.
Redundancy: Notification for a particular event is delivered to multiple devices. Failure to acknowledge or cancel the event within a set amount of time causes the notification to be retried, or escalated to another set of devices.
Accountability: System statistics are recorded. A manager generates a report to determine if adequate response times are being maintained.
Assignment: Assignments between event-generating devices and event-receiving devices change at the start of every shift. Preset assignment schedules are automatically applied, and modifications manually entered.
Transparency: The assignment process for an end-user is always identical, regardless of what proprietary systems are being incorporated.

In particular, the present invention is directed to an event management system for managing event notifications between disparate systems. The event management system of the present invention provides for: capture of event notifications from any external systems or devices capable of generating an event notification; processing of said event notifications through a multitude of user-configurable settings including selection of one or more other systems or devices capable of receiving an event notification through assignment of one or more event notification paths based upon one or more of the nature of the event notification, the first external system or device and the one or more other systems or devices; delivery of said event notifications to any internal or external systems or devices capable of receiving an event notification; facilitation of lateral communication between the device that generated an event notification and a device that received it; permanently recording the details of an event notification and its life within the system for any purpose, including auditing. The present invention facilitates comprehensive and multi-tiered programming of the system settings, including the assignment of event notification paths between event-generating devices and event-receiving devices. Such settings may be applied in a static, scheduled or dynamic manner, or any combination of the three.

### BRIEF DESCRIPTION OF THE DRAWINGS

Preferred embodiments of the present invention are illustrated in the attached drawings in which:

FIG. 1 is an illustration of the present invention depicting the physical relationships between software and hardware components;

FIG. 2 is an illustration of the present invention depicting the data flow between software and hardware components;

FIG. 3 is an illustration of a healthcare application of the present invention;

FIG. 4 is an illustration of a building management application of the present invention;

FIG. 5 is an illustration of a retail application of the present invention;

FIG. 6 is an illustration of a manufacturing application of the present invention;

FIG. 7 is an illustration of a courtroom application of the present invention; and

FIG. 8 is an illustration of a mining application of the present invention.

### DETAILED DESCRIPTION OF THE PREFERRED EMBODIMENTS

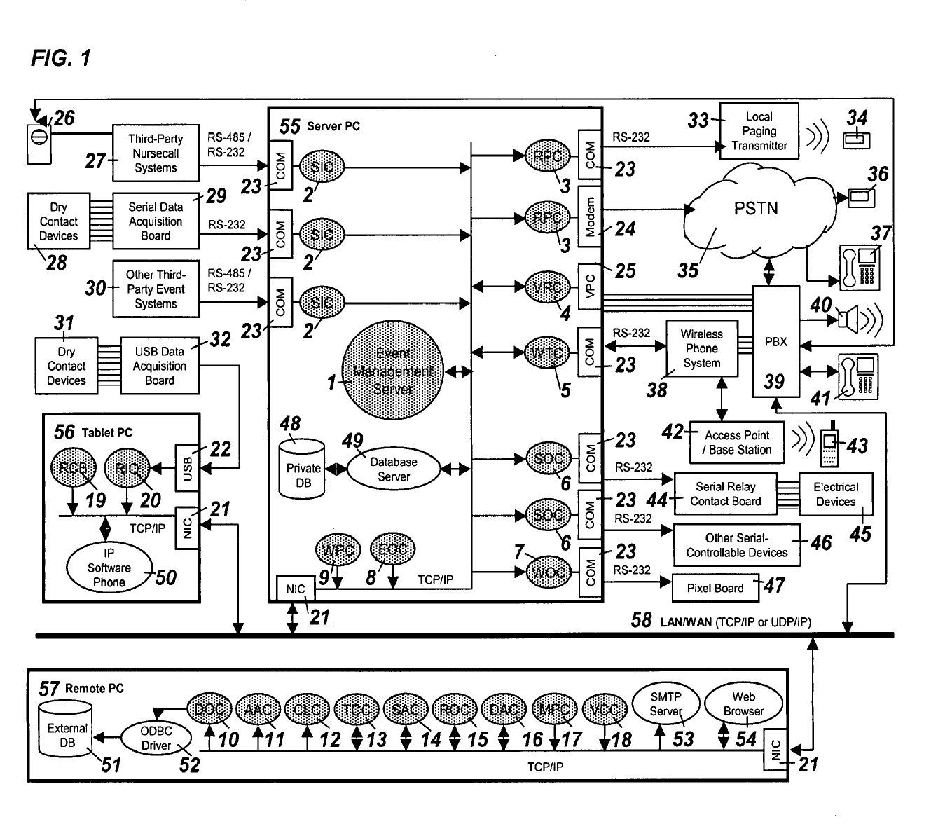

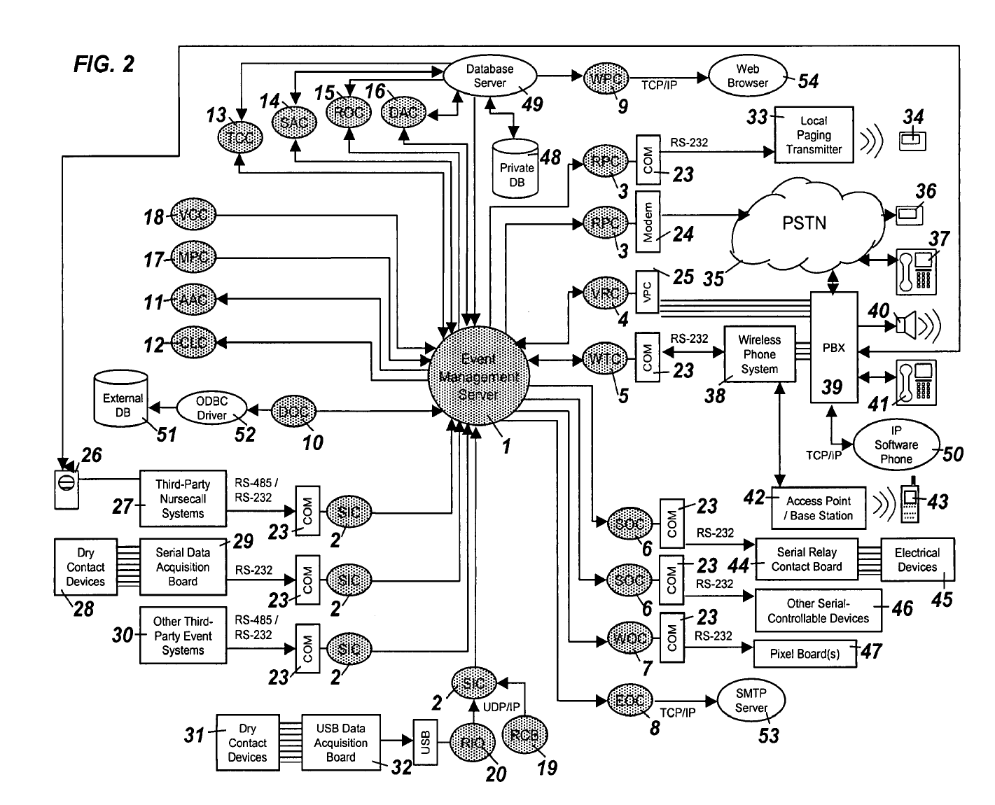

The following summary references FIGS. 1 and 2. The present invention provides an event management system utilizing a central server program 1 and a plurality of client programs to provide intelligent event management and notification between disparate external systems. The software is designed to run on standard PC hardware 55, 56, 57. Any hardware-based external system to which the software is integrated must therefore be capable of connecting to the PC housing the software. The connections typically utilize a serial (RS-232, RS-485, USB) or a network (TCP/IP, UDP/IP over Ethernet) interface. An external system may also be software in nature. Typically, a software-based system will utilize an IP-based communication protocol. Each client program performs a unique function. This might be interfacing with a particular external system, providing a GUI for performing a particular management task, or another purpose.

To best describe the present invention, it is first necessary to define a few terms. We define an event as a measurable and instantaneous change of state. An event is considered to have a lifespan within the present invention. The start of an event's life shall be called activation and the end of an event's life shall be called cancellation. Within the present invention, the representation of a device that generates an event shall be called a callpoint. Similarly, the representation of a device which receives notifications shall be called, simply, a device. Sometimes it is possible for a single physical device to both generate and receive events. In this case the physical device shall be represented twice within the system, as both a callpoint and a device. A callpoint can be virtual. A virtual callpoint is represented within the system, but does not physically exist outside of it. A virtual callpoint can be mapped onto a physical callpoint, so that a single event can be activated and cancelled by both physical and virtual means. Assignment is the process of creating a relationship between a callpoint and a device. If a callpoint is assigned to a device, then events generated by the callpoint will be sent to that device. A single callpoint may be assigned to multiple devices and vice versa. Assignments may be applied in a static, scheduled or dynamic manner or any combination. In particular, the assignment may be dynamically applied to or removed from a specific device in real time. The transfer of information that occurs within the system when an event changes state shall be called event notification. For the most part the terms event notification, callpoint and event may be used interchangeably. The process of activating a callpoint's event shall be called triggering. Besides activation and cancellation, four key actions can be performed on an event: retry, acknowledgement, callback and escalation. Event notification may be retried if an event is not acknowledged or canceled within a set period of time. An acknowledged event is one that has been viewed by a responsible individual. Just because an event has been acknowledged does not automatically mean that the event is cancelled. Callback is a device-specific feature providing lateral communication between a callpoint and a device. If both devices are adequately equipped and the callback action is performed, then a callback path is opened between the device and the callpoint. A typical example: the callpoint is an audio-equipped nursecall station and the device is a wireless phone. Selecting the callback option automatically places a call from the wireless phone to the nursecall station. Escalation of an event means that the recipient forfeits responsibility for said event. The event is then escalated to a higher level of responsibility. The option to escalate an event will not exist if there are no higher-level devices assigned to the callpoint. Cancellation of an event may itself trigger an event such as a cancellation message sent to any callpoints associated with the original event.

The present invention is designed to be completely modular. At the highest level, the modules consist of the server program and each client program together with the system (if applicable) to which it is interfaced. As discussed previously, the job of a client program is to perform a unique function and to isolate the details of that function from the server. Each client program also consists of separate modules. Typically these include a GUI module, a module for communicating with the server, and a module for communicating with an external system. Some of these modules may be excluded from a particular client, and other modules may be added. Clients may themselves have sub-clients, which communicate only with the parent client and not the server. The job of the server is to perform high-level management functions. When an event is received from a client, the server processes it according to the properties of the event, any properties of callpoint or callpoint type, the device assignment and any properties of the assigned devices. The server and clients are intended to be separable and to communicate via TCP/IP and UDP/IP over a LAN or WAN 58. This allows clients to be located on the most convenient PC for any given application. This may be the same PC containing the server or any other computer on the network. If a client requires a physical connection to an external system, it should be located on a PC with an available hardware interface for said system. The server utilizes a private database 48 for storing system configuration and runtime data. Database access is provided by a database server 49 through TCP/IP. This means that that database and the server program need not be located on the same PC. Some clients may also access the database server directly without going through the server program.

The client programs can be classified under the following functions: receiving input from an event-generating system, dispatching output to an event-receiving system, or system management. A client will fit under one or more of these categories. All clients existing at the time of this submission are described below. It is the nature of the present invention that new clients be continuously created as need arises. A new client shall be developed when an external system is discovered that cannot be interfaced to an existing client, or when a new management task is conceived.

The Standard Input Client (SIC) 2 interfaces with standard third-party event systems 30. Most of these systems utilize a serial interface and connect to the PCs COM port 23. Some use TCP/IP or other protocols. One of the most common classes of third-party event systems are Nursecall Systems 27 which provides centralized event notification for a variety of callpoint devices. The callpoint device 26 belonging to the illustrated nursecall system is audio equipped, and is hooked into a line on a businesses' PBX 39. Another common system utilizing a SIC is a Serial Data Acquisition Board 29 which is used to capture events from any Dry Contact Devices 28. Such devices include simple switches, magnetic door locks and motion sensors. A single SIC may receive event notifications from one of two subclients: the Remote Call Button (RCB) 19 or the Remote Input/Output (RIO) 20. The RCB provides a large, virtual pushbutton as a callpoint. The RIO is attached to a Dry Contact Device 31, typically a single large pushbutton, through a USB Data Acquisition Board 32 and the PCs USB port 22.

The Radio Paging Client (RPC) 3 provides event notification to numeric and alphanumeric pagers 34. An RPC may be interfaced with a Local Paging Transmitter 33 via a serial port on the PC. An RPC may also be interfaced to Wide Area Pagers 36 through the PCs modem 24 and the PSTN 35, or through the internet via TCP/IP.

The Voice Response Client (VRC) 4 can both receive and send events. As a sending device, the VRC provides audio event notification to a telephone device. This is achieved through Text-To-Speech (TTS) conversion of a text message into a synthetic human voice. Most commonly the receiving device is a digital or analog handset 41 on the business' PBX. The device may also be a wireless phone 43, an overhead paging system 40 an off-site phone 37 or another device. The VRC connects to the PBX through one or more Voice Processing Cards (VPC) 25 installed in the PC. A Voice Processing Card (VPC) may use digital or analog ports, and typically ranges in capacity from 4 to 64 ports per card. As a two-way communication device, the VRC offers acknowledge, callback and escalate options. This is done through a touch-tone menu. As a receiving device, the VRC can accept incoming calls. Events can be triggered by means of touch-tone input. Voice recognition technology may be used in place of or in conjunction with the touch-tone input.

The Wireless Telephony Client (WTC) 5 can both receive and send events. As a sending device, the WTC provides text-based notification to wireless handsets 43 via remote Access Points 42. Typically the WTC interfaces to the Wireless Phone System 38 through a serial interface, but TCP/IP interfaces are becoming more prevalent. As a two-way communication device, the WTC offers acknowledge, callback and escalate options. This is done through the numbered keys on the handset, or through programmable buttons if available. As a receiving device, a WTC can accept event notifications from a handset through its persistent connection with the Wireless Phone System. A user could trigger an event in this way be entering a special feature code.

The Serial Output Client (SOC) 6 provides notification to dumb serial devices. Typically this will elicit some kind of mechanical response to an event, rather than to display a comprehensive message. Often an SOC is interfaced to a Serial Relay Contact Board 44 which can control any simple electrical device 45. An example: In combination with the receiving features of the WTC, one could use a wireless handset to turn on a light. The SOC may be interfaced to Other Serial Controllable Devices 46. And example of such a device is a closed-circuit security video switch, which will change the video feed it is displaying in response to a command sent via its serial port.

The Wallboard Output Client (WOC) 7 is used to send textual event notifications to a Pixel Board 47 via a serial interface. Typically Pixel Boards are large, scrolling displays. Often multiple Pixel Boards can be linked together and controlled via a single WOC.

The Email Output Client (EOC) 8 provides event notification by email through an SMTP server 53.

The Web Paging Client (WPC) 9 does not need to communicate with the server. Its function is to provide a simple text-paging mechanism through a web-browser 54. Pages are not considered events, they are simply sent through the server to the target device(s). The message to be sent may be selected from a pre-defined message list or entered manually.

The Database Output Client (DOC) 10 is a pure management tool. It receives event notifications from the server like any typical client, but then rather than display said event, the DOC records it in an External Database 51 via an ODBC Driver 52. A user may then collect event data in any ODBC-compatible database of their choosing, and audit the data in a manner completely independent of the event management system of the present invention.

The Active Alarm Client (AAC) 11 is a management tool that receives all event notifications, and displays them through an easily-understandable GUI. The events displayed by the AAC can be restricted based on location. The AAC accesses the database server directly to avoid excessive load on the server.

The Command Line Client (CLC) 12 will run third-party software applications in response to a specific event. The CLC will trigger another executable program, passing in the event notification text as parameters.

The Trigger Callpoint Client (TCC) 13 is a management tool with a very specific function. The system can be programmed so that an event will automatically trigger periodically at a set interval. The TCC is used to toggle this feature on and off. The TCC accesses the database server directly to avoid excessive load on the server.

The Server Administration Client (SAC) 14 is used to remotely perform administrative functions typically performed directly from the server. The SAC accesses the database server directly to avoid excessive load on the server.

The Report Management Client (RMC) 15 is a management utility for generating hard-coded reports from the private database. The generated reports are especially useful for system administrators in debugging assignment or configuration issues. The RMC accesses the database server directly to avoid excessive load on the server.

The Device Assignment Client (DAC) 16 is a management utility for easily creating assignments between callpoints and devices. The DAC accesses the database server directly to avoid excessive load on the server.

The Mapping Alarm Client (MAC) 19 is a management utility to allow assignment and viewing of callpoints in a graphical map like format. A graphical image of the physical location is imported and locations and callpoints may be placed on the graphical display. Drill down and promotion of the map are provided to allow viewing of locations and callpoints at any level of the hierarchy of the location.

The Manual paging Client (MPC) 17 provides a GUI for simple text-paging to devices. Pages are not considered events, they are simply sent through the server to the target device(s). The message to be sent may be selected from a pre-defined message list or entered manually.

The Virtual Callpoint Client (VCC) 18 provides a GUI for controlling virtual callpoints. The VCC allows the user to manually activate or cancel a virtual callpoint. Recall that a virtual callpoint can be mapped onto a physical callpoint. In this case, the VCC can be used to cancel an event that was triggered by a physical callpoint.

Programming of the present invention occurs in two forms, Administration and Assignment. Administration refers to the initial creation of static settings within the system and any continuing maintenance of static settings. Assignment refers to any programming which affects the paths of event notifications from callpoints to devices. The GUIs provided for both administration and assignment are directly related to the way data is represented in the system. Within the present invention, the real world is represented as an object hierarchy (tree). The branch nodes of the tree represent physical locations. Examples of locations include campuses, buildings, floors and rooms. The tree's leaf nodes are objects of the following types:
Callpoints representing event-generating devices,
Callpoints that are purely virtual,
Callpoint Groups representing multiple callpoints,
Devices representing event-receiving devices,
Device Groups representing multiple devices,
Assignment Plans representing a static assignment of callpoints to devices,
Assignment Schedules representing a range of times during which a particular Assignment Plan is automatically activated,
Message Lists representing a static list of pre-defined messages used for manual paging.

During administration the location hierarchy is created and populated with static objects. Each object type has an array of configurable settings that affect how events are managed within the system. A crucial group of settings for the callpoint type directly affect the behavior of event notifications. Each callpoint has three notification levels to which devices can be assigned: primary, secondary and auxiliary. Each level is assigned a retry value and a timeout value. When an event is triggered, notification first goes to any devices assigned at the primary level. If the event has not been canceled or acknowledged before the primary timeout expires, notification is retried. When all retries have been expired, the event escalates to any devices assigned at the secondary level, and then to the auxiliary level. If the event exceeds the set number of retries at the auxiliary level, it is automatically removed from the system. The GUI for Administration contains an icon-based tree-view of the location hierarchy. Objects appear on the screen exactly as they represented within the system.

The GUI for Assignment utilizes the same tree-view. Through assignment one or more other systems or devices capable of receiving an event notification are assigned to one or more event notification paths based upon one or more of the nature of the event notification, the first external system or device and the one or more other systems or devices. Manual assignments are easily made by dragging and dropping callpoints to a specific device, or conversely, by dragging and dropping devices to a specific callpoint. Assignments are made at the primary, secondary and auxiliary notification levels. The use of callpoint and device groups further simplifies the assignment process, facilitating the creation of multiple assignments in just one step. Pre-created assignment plans may be manually toggled on or off, or be automatically activated by an assignment schedule. This layered approach to the assignment process means that routine assignments need only be configured once, and manual modifications are easily superimposed.

The modular nature of present invention makes it highly scalable and infinitely configurable. For example, assignment of event notification paths between event-generating devices and event-receiving devices may be applied in a static, scheduled or dynamic manner, or any combination of the three. In addition, assignment of event notification paths between event-generating devices and event-receiving devices can be dynamically applied to, or removed from a specific device during the event notification. In an additional embodiment cancellation of an event may trigger an event such as a cancellation message sent to any callpoints associated with the original event. This cancellation message may include turning off the original event notification, such as turning off the ringing of a telephone or it may be a separate event notification such as a telephone message or email sent using an appropriate client.

The Preferred embodiments exemplified and discussed below illustrate some practical, real-world configurations for the present invention but are not to be considered as limiting the scope of the invention.

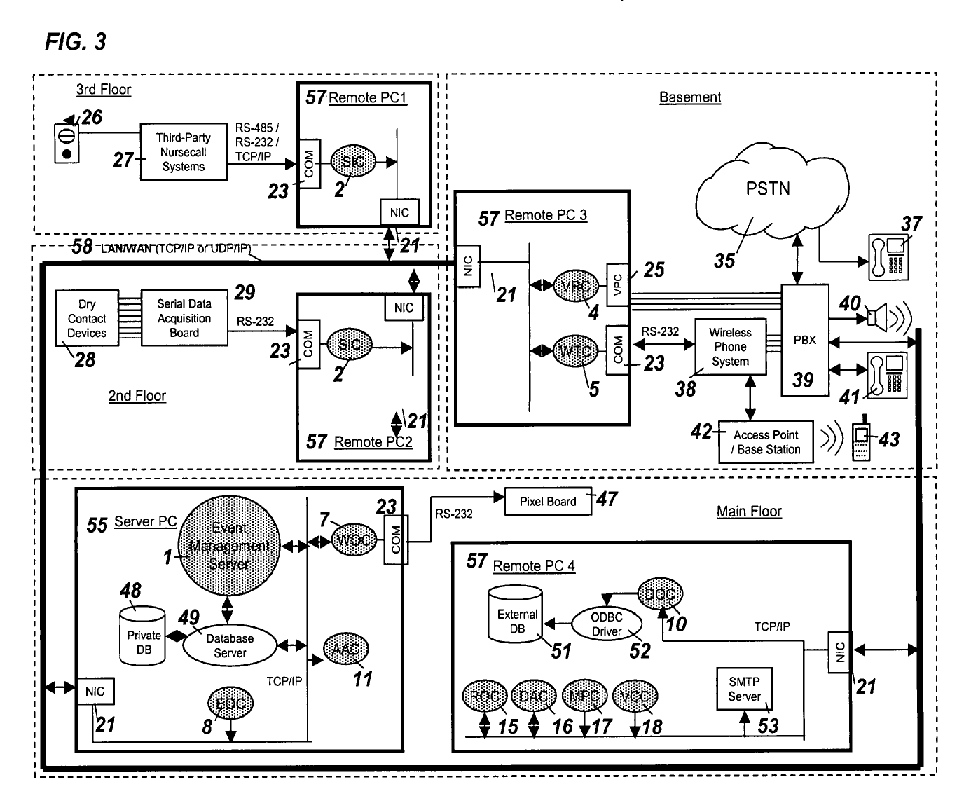

FIG. 3 illustrates a preferred embodiment of the present invention for use in a hospital. The major objectives of the current application are to extend the notification capabilities of existing nursecall systems, to tie together all disparate nursecall and communication systems under a single assignment platform, and to facilitate high-level auditing and accountability. The configuration consists of:
An Event Management Server 1 with a Database Server 49 and Private Database 48.
One DAC 16 at each nursing station for making assignments.
A DOC 10 connected to an External DB 51 through an ODBC Driver 50.
A RMC 15.
Several MPC's 17 to facilitate manual paging.
A VCC 18 in every operating room.
An EOC 8 for sending email notification through the hostipal's SMTP Server 53.
A WOC 7 attached to a Pixel Board 47.
A SIC 2 for every individual nursecall system 27.
A SIC 2 for every legacy (purely electric) nursecall system 28. Such a system usually consists of an array of lights at the nursing station which turn on when a callbutton is pressed. A SIC interfaces to such a system through a Serial Data Acquisition Board 29.
A WTC 5 to interface a wireless phone system 38.
A VRC 4 to provide audio notification to overhead paging 40, and regular telephones both local 41 and remote 37. Audio notification is delivered through a Voice Processing Card (VPC) 25, the hospital's PBX 39 and the PSTN 35.

The current preferred embodiment utilizes very complex device assignments. Nursing staff work in shifts, and their assignments vary from day to day. Nursing supervisors may make full use of assignment plans and assignment schedules. At the start of every shift nursing staff assign the callpoints for which they are responsible to the wireless phone 43 that they carry. Regardless of which nursecall system is installed in their section of the hospital, the assignment process is completely consistent. In the event of a medical emergency, a doctor who is on call at home may receive audio notification on his telephone via the VRC. Each operating room contains a PC with a VCC and a MPC. The VCC can be used to send standard requests for supplies or personnel in an extremely efficient manner. In this case, a nurse triggers a virtual callpoint representing desired request. Notification is automatically delivered to the proper recipient(s). The MPC facilitates the sending of non-standard requests. Any textual message may be sent to a device. Because the system programming in the current preferred embodiment is so complex, problems are likely to arise. A RMC can be used to generate reports which aid nursing supervisors or the system administrator in debugging perceived configuration or assignment problems. Through a DOC upper management may capture event notifications for any subset of the location hierarchy. Reports can then be generated for the purposes of auditing both staff and system effectiveness.

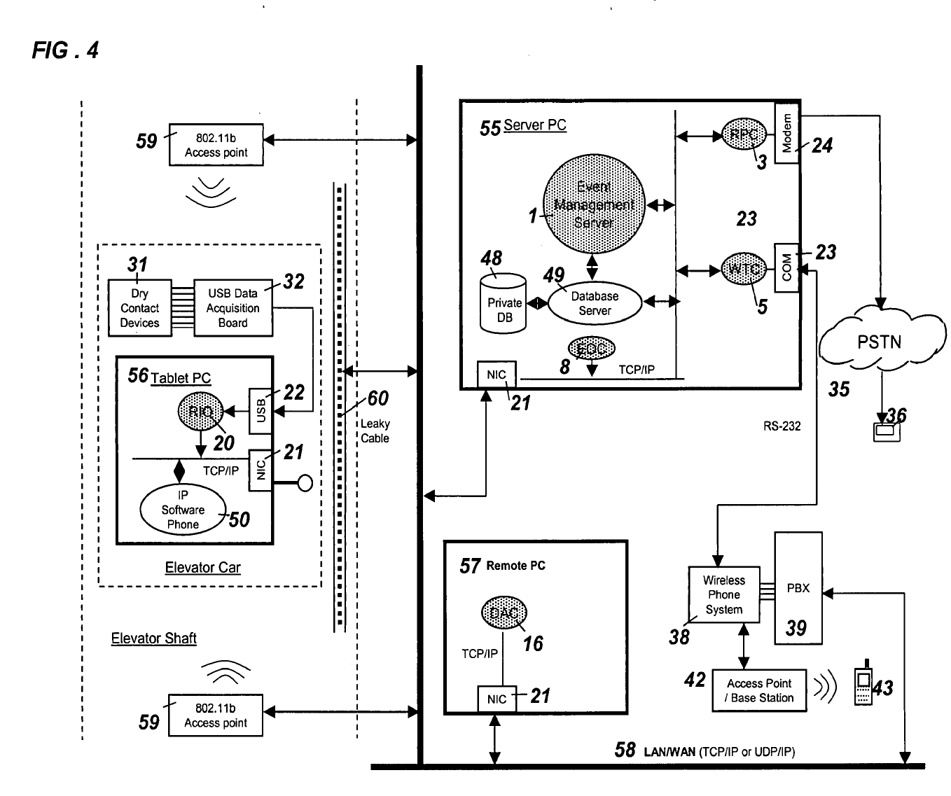

FIG. 4 illustrates a preferred embodiment of the present invention for use in a high-rise building. The major objective of the current application is to provide an ultra-reliable emergency communication system for the building's elevators. A current emergency communication system for an elevator typically consists of an analogue telephone that is physically wired into the building's phone system. When a passenger in the elevator lifts the receiver, the phone is automatically connected to the desk set of a security guard. The guard must be physically present to answer the call, or the emergency will go unheeded. There are two inherent flaws in this design. Because the elevator is constantly moving, the likelihood that the wires connecting the emergency phone to the building's phone system will break is very high. Because an on-hook phone appears electrically identical to an open circuit (a high-impedance state) there is no way to be automatically notified when the connection breaks. The only way to ensure the emergency phone is operational is to manually test it by placing a call from an elevator. Usually the discovery that the connection is broken does not occur until a stuck passenger tries to use the phone during an actual emergency. The current preferred embodiment of the present invention solves all of these issues. The configuration consists of:
An Event Management Server 1 with a Database Server 49 and Private Database 48.
A DAC 16 for making assignments.
An EOC 8.
A WTC 5 connected to a Wireless Phone System 38.
A RPC 3 connected to a public paging system through the PSTN 35 and the PCs modem 24.
Inside a protective glass enclosure in the elevator cab: a Tablet PC 56 housing an IP Software Phone 50 and a RIO 20 connected to the emergency call button on the elevator's control panel through a USB Data Acquisition Board 32 and a USB port 22 on the Tablet.
The Tablet PC inside the elevator must be permanently connected to the LAN 58. Uninterrupted wireless network coverage within the elevator shaft is provided through any combination of 802.11b Wireless Access Points 59 and Leaky Cable 60. The Tablet PC will run off the elevator cab's power supply.

In an emergency, the passenger presses the emergency button on the elevator's control panel. This sends a notification to the wireless phone 43 of the building's security guard. The guard then utilizes the callback option on his wireless phone to place a call back to the IP Software Phone on the Tablet PC. Notification is simultaneously sent to the pager of the proper maintenance person. This frees the guard from having to contact maintenance, allowing him to concentrate fully on the passengers in the elevator. If the Tablet PC has a built-in webcam, the Security guard can utilize video conferencing software to view the elevator car from his PC. If, at any time, the IP communication link with the Tablet PC is broken, a virtual callpoint is triggered. This callpoint would be assigned to the pager of a maintenance person, and to the email account of the elevator company. This supervised communication path means that any failure of the emergency contact system can be immediately remedied.

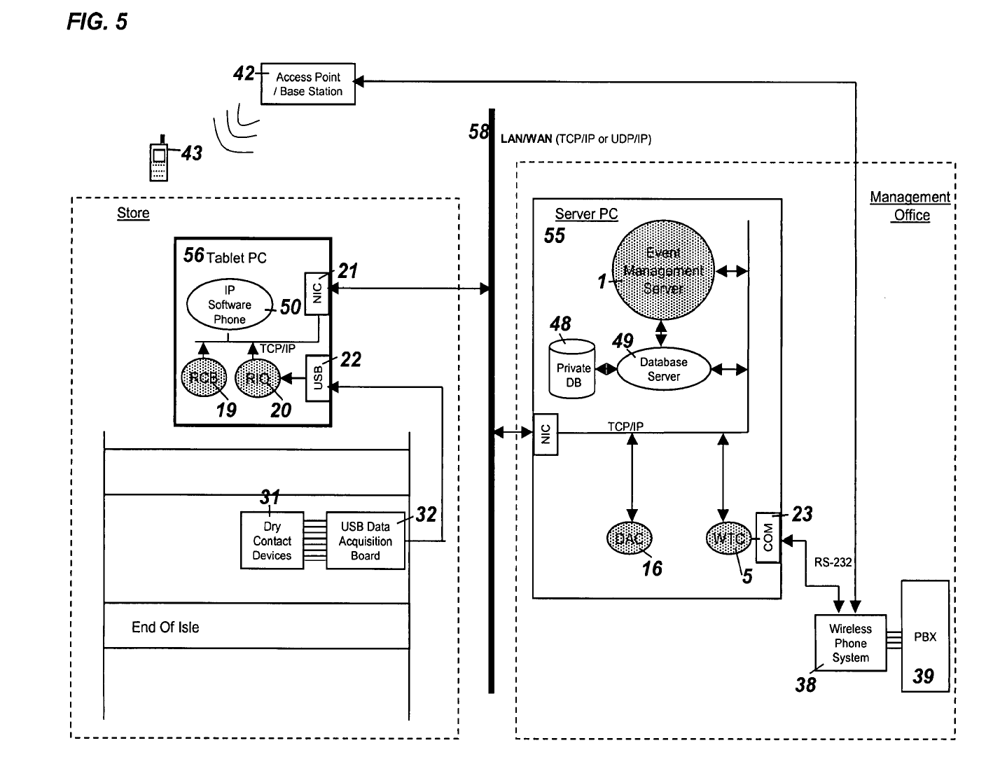

FIG. 5 illustrates a preferred embodiment of the present invention for use in a large retail store. The major objective of the current application is to notify a roaming associate of a customer request for assistance in a specific area of the store. The configuration consists of:
An Event Management Server 1 with a Database Server 49 and Private Database 48.
A DAC 16 for making assignments.
A WTC 5 connected to a Wireless Phone System 38.
At the end of each isle: a Tablet PC 56 housing an IP Software Phone 50 and either a RCB 19 or a RIO 20 connected to a single pushbutton 31 through a USB Data Acquisition Board 32 and a USB port 22 on the Tablet.

A customer requests assistance at their location by pressing either the virtual callbutton displayed on a Tablet PC by the RCB or the physical callbutton attached to the Tablet PC through the RIO. Event notification is sent to the wireless phone(s) of the responsible associate(s). The associate may then walk to the customer's location to assist the customer in person. Alternatively, the associate may use the callback option on their wireless handset to establish voice communication with the IP Software Phone on the Tablet PC and assist the customer remotely.

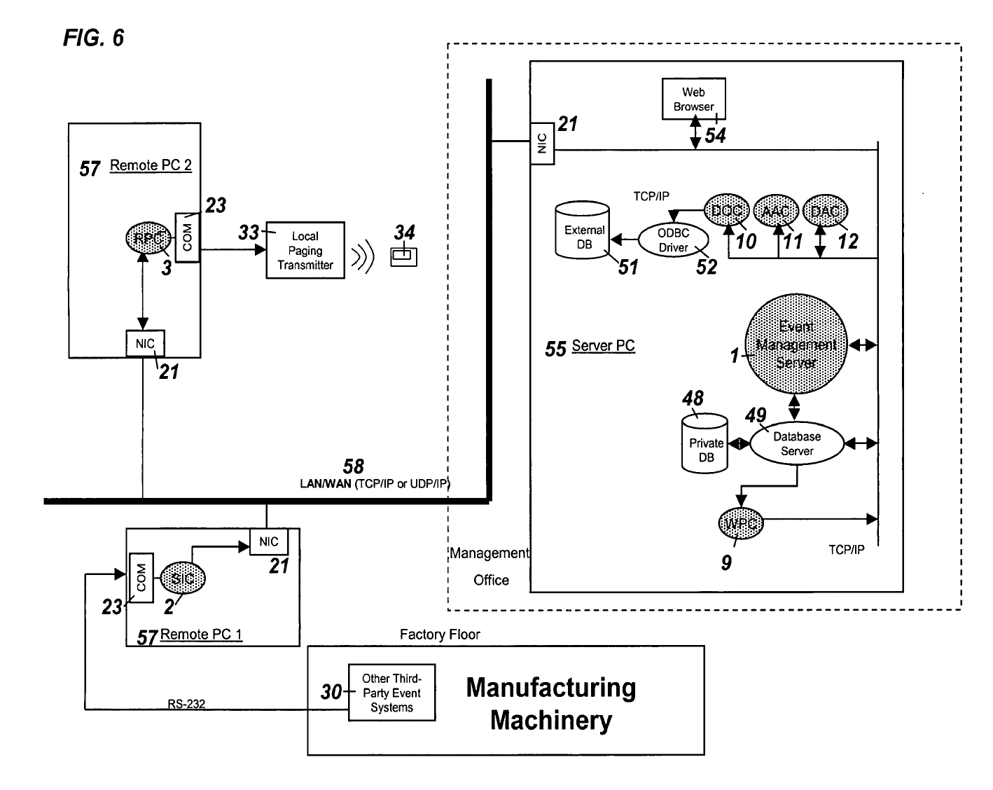

FIG. 6 illustrates a preferred embodiment of the present invention for use in a factory. The major objective of the current application is to provide instantaneous, automatic notification of manufacturing equipment malfunction. The configuration consists of:
An Event Management Server 1 with a Database Server 49 and Private Database 48.
A DAC 16 for making assignments.
A RPC 3 connected to a Local Paging Transmitter 33.
A SIC 2 connected the Third-Party Manufacturing Equipment 30.
A DOC 10 to provide advanced reporting functionality. The DOC is connected to an External Database 51 through on ODBC Driver 52.
An AAC 11 to facilitate general supervision.
A WPC 9 for manual paging through a Web Browser 54 on a manager's computer.

The present invention is connected to the Third-Party Manufacturing Equipment via an SIC on a remote PC 57 located on the factory floor. Callpoints representing various state changes in the Manufacturing Equipment are assigned to Local Area Pagers 34 assigned to plant maintenance personnel. These callpoints would also be assigned to the External Database. When an equipment malfunctions occurs, the correct maintenance personnel are immediately notified. The callpoint status is displayed on the AAC, bringing the malfunction to the supervisor's attention. The event also exported to the External Database. This allows management to generate reports, analyzing the reliability of the equipment and the efficiency of personnel.

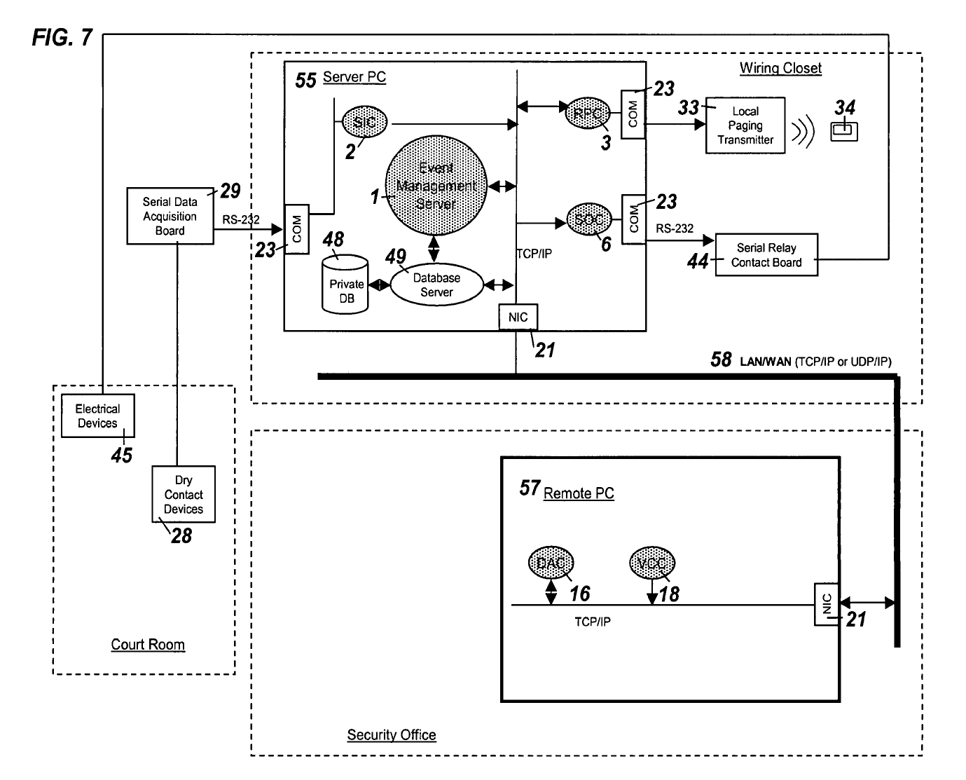

FIG. 7 illustrates a preferred embodiment of the present invention for use in a courthouse. The major objective of the current application is to provide a hidden, supervised means for a judge to contact security under threat of bodily harm. The configuration consists of:
An Event Management Server 1 with a Database Server 49 and Private Database 48.
A DAC 16 for making assignments.
A VCC 18.
An RPC 3 connected to a Local Paging Transmitter 33.
A SOC 6 connected to a Serial Relay Contact Board 44 which drives a single electric light 45. The light is connected in serial to two relays on the Serial Relay Contact Board, one normally open and the other normally closed.
A SIC connected to a Serial Data Acquisition Board 29 connected to a single pushbutton 28.

Typically, two PCs would be required. A remote PC 57 located at the security station would house the DAC and VCC. A server PC 55 located in a wiring closet would house the rest of the components. In the courtroom, the pushbutton is mounted on the underside of the judge's bench. The electric light is mounted on the ceiling in a manner visible only to the judge. The callpoint representing the pushbutton is assigned to a Local Area Pager 34 worn by the courthouse security officer. The callpoint is also assigned to the device representing the normally-open relay contact wired to the electric light. A virtual callpoint is created and mapped to the pushbutton. If the judge is being threatened and requires assistance from security, he presses the panic button under his bench. This notifies the security guard on his pager and closes the relay contact, turning on the light. The light indicates to the judge that help is on the way. By design, the event cannot be canceled via the pushbutton. The event can only be canceled by security via the virtual callpoint. Once the situation has been resolved, the security guard cancels the event using the VCC at the security desk. It is also important for the judge to know if his panic request has been received. To achieve this, a virtual callpoint representing failure of the Local Paging Transmitter is assigned to the normally-closed relay. If, at any time, the paging transmitter fails, the failure event causes the relay to open, disabling the light.

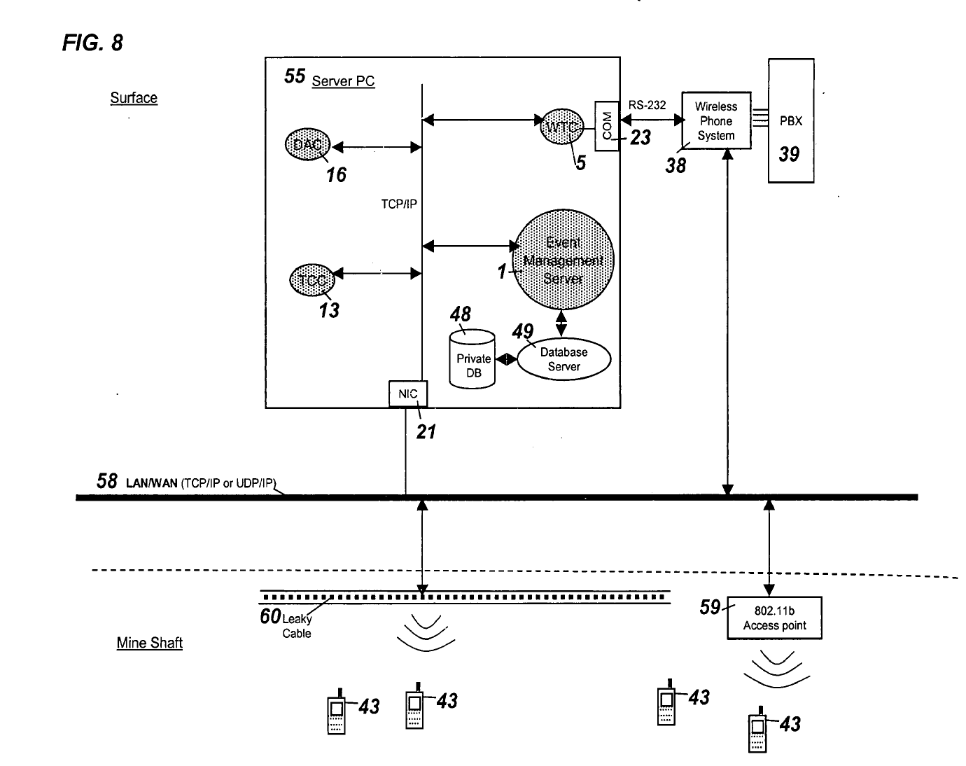

FIG. 8 illustrates a preferred embodiment of the event management system of the present invention for use in a mine. The major objective of the current application is to provide automated man-down monitoring. Because mines are dangerous workplaces, it is necessary to continuously monitor workers to ensure that they are safe. To achieve this, workers are required to report in within a set interval. If the worker fails to check-in on time, he is considered “down” and in need of assistance. A supervisor or fellow workers are then sent to his last known location to determine why the worker failed to report in and offer assistance if necessary. In a traditional monitoring system, a supervisor is given the full-time job of manually recording the status of every worker. To report in, a worker must leave the area in which he is working, and call the supervisor from a centralized phone. It is the supervisor's responsibility to notice when a worker fails to check in, and to then delegate a team to investigate. This system wastes a great deal of time, forcing workers to leave their posts on a regular basis. It is also vulnerable to human error as the supervisor must manually track the status of all of his workers. In a recent modification to the existing system, each worker is given a cell phone on which to report in. This saves on time, but adds greatly to the hardware cost as the custom cell phone service is extremely expensive. The element of human error is not addressed. The preferred embodiment of the present invention illustrated in FIG. 8 address three issues of time, cost and human error. The configuration consists of:
An Event Management Server 1 with a Database Server 49 and Private Database 48.
A DAC 16 for making assignments.
A TCC 13 for enabling automated callpoint triggering.
A WTC 5 connected to an IP-based Wireless Phone System 38. The Wireless Phone System may be connected to the WTC through a PC serial port 23 as illustrated, or through the LAN 58 using TCP/IP. The IP-based Wireless Phone System uses 802.11b wireless networking and is hence connected to its wireless handsets 43 through the LAN and wireless network. 802.11b wireless coverage inside the mine is provided through Wireless Access Points 59 or Leaky Cable 60.

Each miner is given a wireless handset. For each handset a virtual callpoint is created. The callpoint is set to trigger automatically at a set interval. Primary notification is assigned to the miner, secondary notification is assigned to a supervisor and auxiliary notification is assigned to fellow workers. At the preset interval, the virtual callpoint is automatically triggered. The miner receives notification on his wireless handset. If he acknowledges, the event is automatically canceled and his status is considered OK. If he fails to acknowledge, the system may automatically retry notification. After a set timeout, the system will automatically escalate to the secondary notification level and send the event to the supervisor's handset. This supervisor is thus automatically informed that something is wrong, and may try using the callback feature to call the minor on his wireless handset. The supervisor may also immediately escalate the event to the auxiliary recipients. The auxiliary recipients are the minor's co-workers. Upon receiving notification they would know to immediately check on their comrade.

The event management system of the present invention is also ideally suited for use in an emergency preparedness center. The major objectives of the current application are to extend the notification capabilities of emergency preparedness centers to provide for proper staffing levels of emergency workers based on the nature and extent of the emergency, and to facilitate high-level auditing and accountability. The configuration consists of:
An Event Management Server 1 with a Database Server 49 and Private Database 48.
One or more DAC 16 for making assignments.
A DOC 10 connected to an External DB 51 through an ODBC Driver 50.
A RMC 15.
Several MPC's 17 to facilitate manual paging.
One or more VCC's 18 for each emergency service.
An EOC 8 for sending email notification through the emergency preparedness centre's SMTP Server 53.
A WOC 7 attached to a Pixel Board 47.
A SIC 2 for every legacy (purely electric) alarm system 28. A SIC interfaces to such a system through a Serial Data Acquisition Board 29.
A WTC 5 to interface a wireless phone system 38.
A VRC 4 to provide audio notification to overhead paging 40, and regular telephones both local 41 and remote 37. Audio notification is delivered through a Voice Processing Card (VPC) 25, the emergency preparedness centre's PBX 39 and the PSTN 35.

The emergency response system according to the preferred embodiment of the present invention brings diverse emergency and monitoring systems together on a single platform for monitoring of alarms and alerts, and securely and effectively allows real time emergency notification dispatch in a controlled manner. This ensures automatic real time emergency notification dispatch of an event to a special team designated to act upon the respective event.

The emergency management system is programmed with icons representative of each emergency. The current preferred embodiment utilizes very complex device assignments. Based upon the nature and expected extent of the emergency, the relevant emergency responders and numbers or each class of each emergency responder are assigned. Many emergency personnel work in shifts, and their assignments vary from day to day. Emergency personnel supervisors may make full use of assignment plans and assignment schedules. The relevant callpoints for one or more emergency services and personnel are assigned based upon the notification clients for the personnel and the nature and extent of the emergency.

When an emergency is reported to the emergency preparedness centre, the dispatcher selects the appropriate icon representative of the nature of the emergency. The event management system sends notifications to the appropriate personnel of the response team based upon the assignments and the nature and extent of the emergency. If the selected numbers of team members do not respond within the specified time, the notification is escalated to the next set of personnel until acknowledgments are received from the required number of team members for the emergency. The emergency dispatcher can monitor the automated notification of the response team assigned to the emergency event. The emergency response system enhances the support give by Emergency Management departments to hospitals, fire departments, EMS, transport, police and other public safety departments by bringing them together on one single platform for any kind of emergency notification management.

Although various preferred embodiments of the present invention have been described herein in detail, it will be appreciated by those skilled in the art that variations may be made thereto without departing from the spirit of the invention.

We claim:

1. An event management system for managing event notifications between disparate systems comprising a means to capture event notifications from a first external system or device capable of generating an event notification; a means to process said event notifications through a multitude of user-configurable settings, including selection of one or more other systems or devices capable of receiving an event notification through assignment of one or more event notification paths based upon one or more of the nature of the event notification, the first external system or device and the one or more other systems or devices; a means to deliver said event notifications to said other systems or devices capable of receiving an event notification based upon the assignment of the one or more event notification paths; a means to facilitate lateral communication between the first device that generated an event notification and a said one or more other systems or devices that received it; a means to permanently record the details of an event notification including the nature of the event notification, the first external system that generated the event notification and the one or more other systems or devices that received the event notification and its life within the system for any purpose, including auditing.

2. An event management system according to claim 1 wherein assignment of event notification paths between event-generating devices and event-receiving devices are applied in a static, scheduled or dynamic manner, or any combination of the three.

3. An event management system according to claim 2 wherein the assignment of event notification paths between event-generating devices and event-receiving devices can be dynamically applied to, or removed from a specific device during the event notification.

4. An event management system according to claim 3 wherein the assignment of event notification paths between event-generating devices and event-receiving devices can be applied in a transitory manner so that they automatically expire when the given event notification expires, and as such, will not persist to subsequent event notifications originating from the same first external system or device.

5. An event management system according to claim 1 wherein additional textual and/or binary data is statically associated with the first external system or device and may be incorporated into the event notification from the first external system or device.

6. An event management system according to claim 1 wherein additional textual and/or binary data is dynamically associated with the first external system or device and may be incorporated into the event notification from the first external system or device.

7. An event management system according to claim 1 wherein the system includes a means to provide a detailed synopsis of an event notification delivery status' pertinent to any given first external system or device.

8. An event management system according to claim 7 wherein the delivery status details may be updated in real-time and may include delivery status disposition.

9. An event management system according to claim 7 wherein the delivery status disposition includes delivered, failed, and/or rejected.
